(19) United States
(12) Patent Application Publication
(10) Pub. No.: US 2024/0103887 A1
(43) Pub. Date: Mar. 28, 2024

(54) STANDALONE DYNAMIC LINK EDITOR

(71) Applicant: Apple Inc., Cupertino, CA (US)

(72) Inventors: Aleksandar RISTOVSKI, Ottawa (CA); Michael DANIELS, Stittsville (CA); Ryan J. MANSFIELD, Stittsville (CA)

(21) Appl. No.: 18/213,767

(22) Filed: Jun. 23, 2023

Related U.S. Application Data
(60) Provisional application No. 63/409,533, filed on Sep. 23, 2022.

(51) Int. Cl. G06F 9/445

(52) U.S. Cl. CPC G06F 9/44521

(57) ABSTRACT

This disclosure provides techniques for executing a software program by separating a dynamic link editor from a process executing the software program. For example, the dynamic link editor can reside outside of the process being dynamically linked and would perform dynamic linking operations for the process before the process executes its first instruction. Such techniques optionally complement or replace other methods for executing a software program.

### CROSS-REFERENCE TO RELATED APPLICATIONS

The present application claims benefit of U.S. Provisional Patent Application Ser. No. 63/409,533, entitled “STANDALONE DYNAMIC LINK EDITOR” filed on Sep. 23, 2022, which is hereby incorporated by reference in its entirety for all purposes.

### BACKGROUND

A software program includes a set of instructions that are executable to perform a task. Typically, the set of instructions are stored in a first type of memory (e.g., long-term memory) and loaded by a system component (e.g., a process loader) into a second type of memory (e.g., short-term memory) for execution. The set of instructions can require performing one or more dynamic linking operations (e.g., initialization and/or configuration, such as relocation and symbol resolution) before or during execution of the set of instructions. Such dynamic linking operations are performed by a dynamic link editor that is part of a process executing the set of instructions (e.g., included in memory designated for the process).

### SUMMARY

Current techniques for executing a software program are generally ineffective and/or inefficient. This disclosure provides more effective and/or efficient techniques for executing a software program by separating a dynamic link editor from a process executing the software program. For example, the dynamic link editor can reside outside of the process being dynamically linked and would perform dynamic linking operations for the process before the process executes its first instruction. Such techniques optionally complement or replace other methods for executing a software program.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a compute system.

FIG. 2 is a block diagram illustrating a device with interconnected subsystems.

FIG. 3 is a block diagram illustrating some techniques for executing a software program.

FIG. 4 is a block diagram illustrating an dynamic link editor executing in a process.

FIG. 5 is a block diagram illustrating a dynamic link editor separate from a process executing a software program.

FIG. 6 is a block diagram illustrating a dynamic link editor locally loading a dynamic library for use with other processes.

FIG. 7 is a flow diagram illustrating a method for executing a software program.

### DETAILED DESCRIPTION

The following description sets forth exemplary techniques, methods, parameters, systems, computer-readable storage mediums, and the like. It should be recognized, however, that such description is not intended as a limitation on the scope of the present disclosure. Instead, such description is provided as a description of exemplary embodiments.

Methods described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that is capable of determining whether the one or more conditions have been satisfied without explicitly repeating steps of a method until all of the conditions upon which steps in the method are contingent have been satisfied. A person having ordinary skill in the art would also understand that, similar to a method with contingent steps, a system or computer readable storage medium can repeat the steps of a method as many times as needed to ensure that all of the contingent steps have been performed.

Although the following description uses terms “first,” “second,” etc. to describe various elements, these elements should not be limited by the terms. In some examples, these terms are used to distinguish one element from another. For example, a first subsystem could be termed a second subsystem, and, similarly, a subsystem device could be termed a subsystem device, without departing from the scope of the various described embodiments. In some examples, the first subsystem and the second subsystem are two separate references to the same subsystem. In some embodiments, the first subsystem and the second subsystem are both subsystem, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

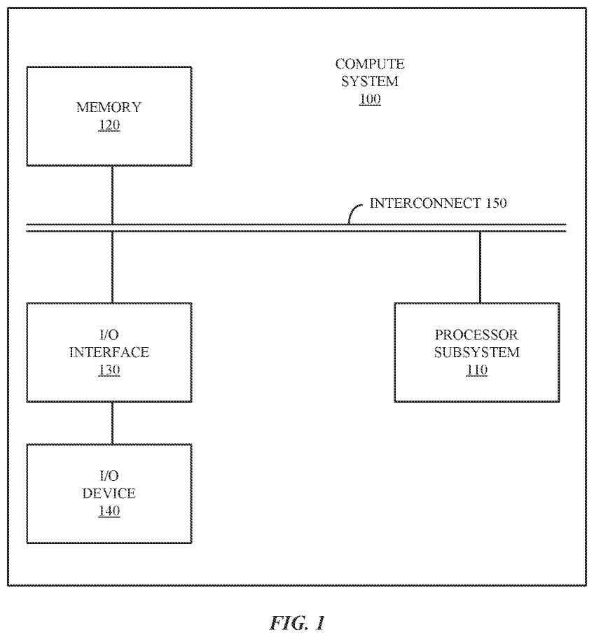

Turning to FIG. 1, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 coupled (e.g., wired or wirelessly) to memory 120 (e.g., a system memory) and I/O interface 130 via interconnect 150 (e.g., a system bus, one or more memory locations, or other communication channel for connecting multiple components of compute system 100). In addition, I/O interface 130 is coupled (e.g., wired or wirelessly) to I/O device 140. In some examples, I/O interface 130 is included with I/O device 140 such that the two are a single component. It should be recognized that there can be one or more I/O interfaces, with each I/O interface coupled to one or more I/O devices. In some examples, multiple instances of processor subsystem 110 can be coupled to interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some examples, compute system 100 is included with or coupled to a physical component for the purpose of modifying the physical component in response to an instruction. In some examples, compute system 100 receives an instruction to modify a physical component and, in response to the instruction, causes the physical component to be modified. In some examples, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some examples, a sensor includes one or more hardware components that detect information about a physical environment in proximity to (e.g., surrounding) the sensor. In some examples, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some examples, a sensor includes a combination of multiple sensors. In some examples, sensor data is captured by fusing data from one sensor with data from one or more other sensors. Although a single compute system is shown in FIG. 1, compute system 100 can also be implemented as two or more compute systems operating together.

In some examples, processor subsystem 110 includes one or more processors or processing units configured to execute program instructions to perform functionality described herein. For example, processor subsystem 110 can execute an operating system, a middleware system, one or more applications, or any combination thereof.

In some examples, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive eXecutive (AIX), network operating systems (e.g., Microsoft Windows Server), and real-time operating systems (e.g., QNX). In some examples, the operating system includes various procedures, sets of instructions, software components, and/or drivers for controlling and managing general system tasks (e.g., memory management, storage device control, power management, or the like) and for facilitating communication between various hardware and software components. In some examples, the operating system uses a priority-based scheduler that assigns a priority to different tasks that processor subsystem 110 can execute. In such examples, the priority assigned to a task is used to identify a next task to execute. In some examples, the priority-based scheduler identifies a next task to execute when a previous task finishes executing. In some examples, the highest priority task runs to completion unless another higher priority task is made ready.

In some examples, the middleware system provides one or more services and/or capabilities to applications (e.g., the one or more applications running on processor subsystem 110) outside of what the operating system offers (e.g., data management, application services, messaging, authentication, API management, or the like). In some examples, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some examples, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some examples, a message sent from a first node in a graph architecture to a second node in the graph architecture is performed using a publish-subscribe model, where the first node publishes data on a channel in which the second node is able to subscribe. In such examples, the first node can store data in memory (e.g., memory 120 or some local memory of processor subsystem 110) and notify the second node that the data has been stored in the memory. In some examples, the first node notifies the second node that the data has been stored in the memory by sending a pointer (e.g., a memory pointer, such as an identification of a memory location) to the second node so that the second node can access the data from where the first node stored the data. In some examples, the first node would send the data directly to the second node so that the second node would not need to access a memory based on data received from the first node.

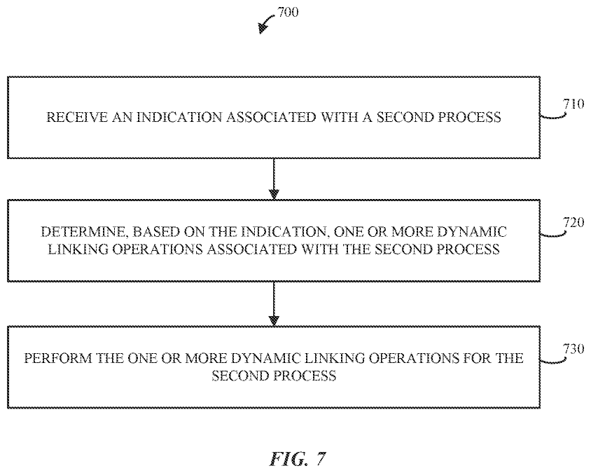

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with the flow described in FIG. 7.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some examples, these other forms of storage can also store program instructions executable by processor subsystem 110 to perform operations described herein. In some examples, processor subsystem 110 (or each processor within processor subsystem 110) contains a cache or other form of on-board memory.

I/O interface 130 can be any of various types of interfaces configured to couple to and communicate with other devices. In some examples, I/O interface 130 includes a bridge chip (e.g., Southbridge) from a front-side bus to one or more back-side buses. I/O interface 130 can be coupled to one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some examples, compute system 100 is coupled to a network via a network interface device (e.g., configured to communicate over Wi-Fi, Bluetooth, Ethernet, or the like). In some examples, compute system 100 is directly or wired to the network.

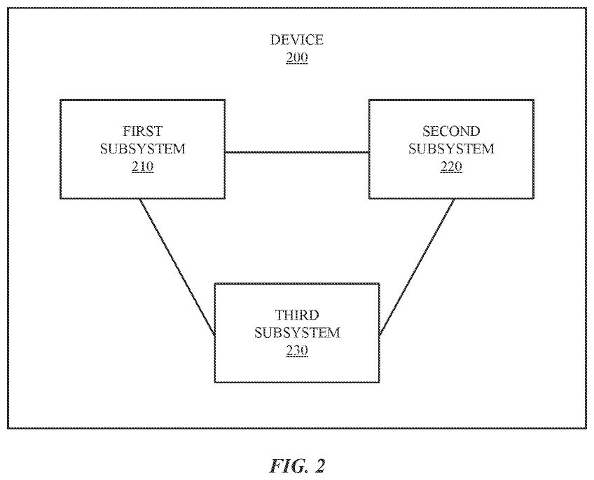

FIG. 2 illustrates a block diagram of device 200 with interconnected subsystems. In the illustrated example, device 200 includes three different subsystems (i.e., first subsystem 210, second subsystem 220, and third subsystem 230) coupled (e.g., wired or wirelessly) to each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1 (i.e., compute system 100). Although three subsystems are shown in FIG. 2, device 200 can include more or fewer subsystems.

In some examples, some subsystems are not connected to other subsystem (e.g., first subsystem 210 can be connected to second subsystem 220 and third subsystem 230 but second subsystem 220 cannot be connected to third subsystem 230). In some examples, some subsystems are connected via one or more wires while other subsystems are wirelessly connected. In some examples, messages are set between the first subsystem 210, second subsystem 220, and third subsystem 230, such that when a respective subsystem sends a message the other subsystems receive the message (e.g., via a wire and/or a bus). In some examples, one or more subsystems are wirelessly connected to one or more compute systems outside of device 200, such as a server system. In such examples, the subsystem can be configured to communicate wirelessly to the one or more compute systems outside of device 200.

In some examples, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some examples, device 200 is configured to navigate (with or without user input) in a physical environment.

In some examples, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some examples, at least a portion of device 200 functions as a distributed compute system. For example, a task can be split into different portions, where a first portion is executed by first subsystem 210 and a second portion is executed by second subsystem 220.

As used herein, source code (sometimes referred to as assembly, uncompiled, or programming code) includes code written by a programmer (sometimes referred to as a developer) using a programming language which is comprehensible to appropriately trained persons and is not capable of directly being used to give one or more instructions to a processor. As used herein, object code (sometimes referred to as executable code) includes machine code (e.g., code readable by a processor when loaded into memory and used directly by the processor to execute one or more instructions) and/or byte code (e.g., code readable by an interpreter during runtime and used by the interpreter to execute one or more instructions by a processor). As used herein, compile time is the time at which source code is converted into object code. In some examples, such conversion can be performed by a compiler and/or an assembler. As used herein, runtime is the time at which one or more instructions of object code are executing by a processor. In some examples, such execution can be performed by a program loader in response to a request to execute the object code. As used herein, a process is an instance of a computer program that is being executed by an operating system on one or more processors. As used herein, a node is an abstraction for one or more operations (e.g., software instructions) of a graph application. As used herein, an edge is an abstraction for sending and/or receiving data by a node. In some examples, an edge is a channel for which data is sent and/or received by a node, the channel used for sending and/or receiving data at different times. As used herein, “sending” data from one node to another node can refer to either actually sending the data to the other node or storing the data such that the other node can access the data (such as through a publication and subscription model). An example of actually sending the data to the other node includes addressing a message including the data to the other node. An example of storing the data includes notifying the other node that the data has been stored (and optionally notifying where the data has been stored through, for example, a pointer to a memory location) and the other node accessing the data where it has been stored. In another example, storing the data can not include notifying the other node that the data has been stored and instead the other node requests (e.g., at a fixed or variable rate) to access a known location for the data.

Attention is now directed towards techniques for executing a software program. Such techniques are described in the context of a microprocessor system with the software program organized in one or more files including machine code (e.g., program code or text) and/or data to be used by the machine code. The files can be organized in any format, such as Mach object file format (Mach-O) or Executable and Linkable Format (ELF). It should be understood that other types of systems and other ways to define a software program are within scope of this disclosure and can benefit from techniques described herein. For example, the software program can be defined in source code.

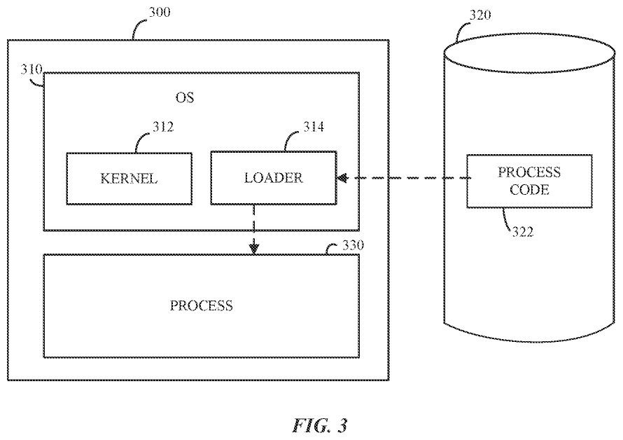

As mentioned above, a software program can be organized in one or more files. A system component (e.g., a process loader, sometimes referred to as a loader) is capable of interpreting at least a portion of the one or more files to prepare the software program for execution. Such preparation can include causing (1) allocation of a section of virtual memory to the software program to form the software program's useable memory (e.g., address space), (2) addition of code for the software program to the section of virtual memory, and (3) creation and/or execution of a process using the section of virtual memory. Some techniques for performing such operations are described below with respect to FIG. 3.

FIG. 3 is a block diagram illustrating some techniques for executing a software program. The block diagram includes computer system 300 and storage system 320 (e.g., any hardware capable of holding information either temporarily or permanently, sometimes including different types of memory such as long-term (e.g., hard drive) and short-term (e.g., random-access memory) memory). Computer system 300 is coupled (e.g., wired to wirelessly) to storage system 320 such that computer system 300 can communicate with storage system 320. In some examples, computer system 300 includes storage system 320 such that processes executing on computer system 300 can locally access storage system 320. In some examples, computer system 300 includes one or more features of compute system 100, device 200, and/or storage system 320.

As illustrated, storage system 320 includes (e.g., is storing and/or has stored) process code 322. Process code 322 corresponds to a software program and includes a set of instructions that are executable by one or more processors to initiate and execute the software program. In some examples, process code 322 is machine binary code and is accessible by computer system 300 for execution by a process (e.g., process 330) of computer system 300. In some examples, storage system 320 stores other code for related and/or unrelated functions (e.g., other software programs).

As illustrated, computer system 300 includes (e.g., is executing and/or is configured to execute) operating system 310. Operating system 310 manages one or more resources of computer system 300 and provides an interface between computer system 300 and a user. Operating system 310 can include different components, such as kernel 312 and loader 314.

Kernel 312 performs one or more operations, which can include operations for memory management, disk management, process management, and task management. In some examples, kernel 312 acts as a bridge between applications and data processing performed at the hardware level using inter-process communications and system calls.

Loader 314 (sometimes referred to as a process loader) is the part of an operating system that is responsible for loading software programs. For example, in response to a request to execute a software program, loader 314 accesses the software program (e.g., process code 322 from storage system 320), sends a request (e.g., a first system call) to kernel 312 to allocate a section of virtual memory to the software program (e.g., reserves memory local to computer system 300 through a memory mapping operation), adds (e.g., stores or maps) process code 322 into the section of virtual memory, sends a request (e.g., a second system call) to kernel 312 to request initiation of a process for the software program (e.g., process 430, as described with respect to FIGS. 4-6), and causes (e.g., via a third system call to kernel 312) control to be assigned to process 330 for execution of operations associated with the software program.

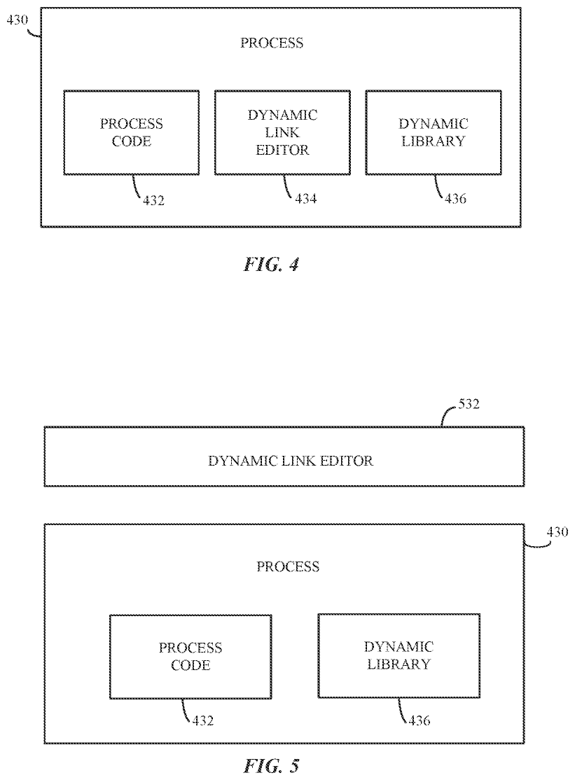

In some examples, process 330 is the process initiated by loader 314 and is responsible for preparing, initiating, and executing the software program, as described below with respect to FIG. 4. In other examples, process 330 is a process separate from the process initiated by loader 314 (e.g., a separate process or loader 314 itself) and is at least responsible for preparing the software program, as described below with respect to FIG. 5. Such preparation in either set of examples sometimes includes loading libraries that are not included in process code 322 (sometimes referred to as dynamic libraries) through a dynamic link editor.

FIG. 4 is a block diagram illustrating dynamic link editor 434 (sometime referred to as an in-process dynamic link editor) executing in process 430. Dynamic link editor 434 is responsible for performing dynamic linking operations associated with process code 322. Dynamic link editor 434 is included in memory of process 430 and, in some examples, executes alongside (e.g., by the same thread and/or process) as operations associated with process code 322 (e.g., operations included in a copy of at least a portion of process code 322, represented as process code 432 in FIG. 4). In some examples, dynamic link editor 434 executes only once (e.g., at startup of the software program corresponding to process code 322) or rarely (e.g., at startup and when adding additional dynamic libraries to process 430 after startup of the software program) while still taking up space in memory of process 430.

In some examples, dynamic link editor 434 is included in process code 322 as a separate binary and is executed first (e.g., after process code 322 has been loaded into process 430). In such examples, dynamic link editor 434 is executing in memory of process 430 and identifies a dynamic library (e.g., dynamic library 436) required by process code 432, causes allocation of memory (e.g., physical or virtual memory) of process 430 (e.g., via an mmap operation) for dynamic library 436, loads dynamic library 436 into the memory, and resolves symbols within process code 432 based on where dynamic library 436 is loaded into memory. In some examples, resolving symbols includes adding references to memory locations for particular operations such that when the particular operations are executed that code corresponding to the particular operations is found. An example of such an operation is “printf,” which would unlikely be included in process code 432 and accordingly required to be added to process 430 by dynamic linking to a printf function definition provided by dynamic library 436 during execution. In some examples, operations performed by dynamic link editor 434 include system calls to a kernel (e.g., kernel 312) to perform operations such as reserving memory and adding data from an outside memory location to a memory location associated with process 430 (e.g., resolving memory location).

In some examples, dynamic link editor 434 iteratively performs similar operations as described above for each dynamic library such that each dynamic library is sequentially added (e.g., one at a time and/or one after the other) to process 430. When dynamic link editor 434 is finished with dynamic linking operations, operations of process code 432 are executed (e.g., the software program begins to execute).

FIG. 5 is a block diagram illustrating dynamic link editor 532 (sometimes referred to as a standalone dynamic link editor) separate from a process executing a software program. As illustrated, dynamic link editor 532 is executing outside of process 430, optionally implemented as a service for process 430. Such a configuration results in code corresponding to dynamic link editor 532 residing in memory outside of process 430.

In some examples, dynamic link editor 532 is executing in its own process (e.g., a user process). In other examples, dynamic link editor 532 is included with a loader of an operating system (e.g., loader 314) and is executing by and in memory space (e.g., address space) of the operating system. When using dynamic link editor 532, loader 314 can pass control to dynamic link editor 534, instead of process 430 when beginning execution of a software program. Accordingly, before process 430 (e.g., a thread of process 430) begins executing an operation, dynamic link editor 534 (1) interprets one or more load commands for process code 322 and one or more libraries for process code 322 and (2) generates a memory image of process 430. Once the process image has been generated in memory, dynamic link editor 532 signals to a kernel (e.g., kernel 312) that process 430 can start executing and the kernel responds by passing control to process 430. In some examples, to provide such functionality, the kernel provides the ability for dynamic link editor 534 to map (e.g., form) memory with respect to (e.g., in a memory space of) process 430 even though dynamic link editor 534 is not executing in process 430.

In some examples, dynamic link editor 532 is executing in memory of its own process and, similar to dynamic link editor 434 of FIG. 4, identifies a dynamic library (e.g., dynamic library 436) required by process code 432, causes allocation of memory (e.g., physical or virtual memory) of process 430 (e.g., via an mmap operation) for dynamic library 436, loads dynamic library 436 into the memory of process 430 or into a process image that is later moved to the memory of process 430, and resolves symbols within process code 432 based on the memory allocated for dynamic library 436. One difference between dynamic link editor 434 and dynamic link editor 532 is that dynamic link editor 532 is performing dynamic linking operations on behalf of process 430 even though dynamic link editor 532 is not executing by process 430 or even in memory corresponding to process 430. Instead, dynamic link editor 532 is executing separate from process 430 using memory not allocated for process 430. In some examples, because operations are performed outside of process 430, process 430 does not need to provide I/O permission(s) for dynamic linking operations. Such I/O permission(s) need to be provided to dynamic link editor 534, which increases security of process 430 and does not require any pledging to remove I/O permission(s) after execution of a dynamic link editor within process 430.

As mentioned above, such dynamic linking operations can be performed with respect to a process image that is added to process 430 to begin execution by process 430. In some examples, dynamic link editor 532 generates a process image in memory local to dynamic link editor 532 (e.g., remote from process 430). In some examples, process image is generated to include process code 432 and dynamic library 436. In such examples, dynamic link editor 532 loads the process image into process 430 after adding dynamic library 436 (and one or more other dynamic libraries to the process image) so that process 430 can initiate execution of the process image (e.g., initiate execution of a software program corresponding to the process image).

In some examples, process 430 requires adding executable code on demand (referred to as lazy binding herein). In such examples, one or more libraries corresponding to the executable code do not have to be already loaded memory of process 430. Instead, dynamic link editor 532 (1) allocates virtual address ranges for code corresponding to the one or more libraries and data related to the executable code and (2) causes, using memory protection, access by process 430 to this not-yet-populated memory to output an access exception. By registering itself as the exception handler for process 430, dynamic link editor 532 can load one or more libraries upon receiving a request to handle an access exception. In some examples, a benefit of this approach applies to multi-core systems where process 430 can start execution while dynamic link editor 532 is still loading and/or resolving one or more libraries for process 430. Unlike traditional lazy binding, the process described above does not need to be limited to lazy binding of text only.

In some examples, process 430 requires adding dynamic libraries while process 430 is executing (e.g., after startup of the software program corresponding to process code 432 and a new dynamic library is required, such as by executing dlopen command in Linux). In such examples, process 430 sends a request to dynamic link editor 532 for an additional dynamic library. Unlike when process 430 is executing a dynamic link editor (requiring a function call), the request is either a system call to an operating system (e.g., when dynamic link editor 532 is executing by the operating system, such as through a loader of the operation system) or an interprocess communication (IPC) to a process executing dynamic link editor 532 (e.g., when dynamic link editor 532 is executing by a process separate from an operating system and process 430).

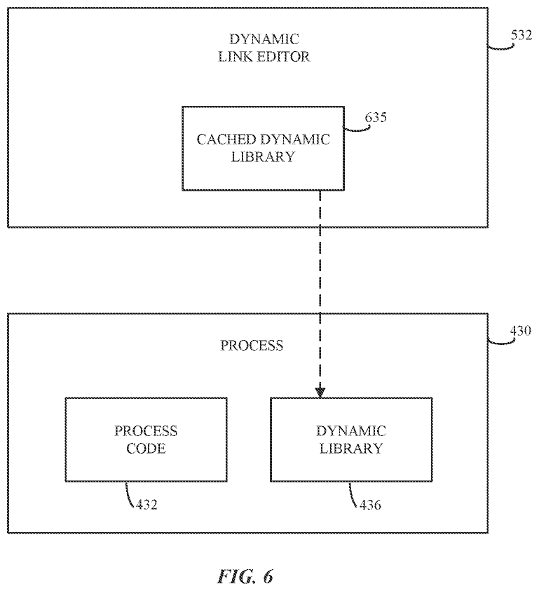

FIG. 6 is a block diagram illustrating dynamic link editor 534 (sometimes referred to as a standalone dynamic link editor) locally loading a dynamic library (referred to as cached dynamic library 635) for use with other processes. As illustrated, dynamic link editor 534 includes (e.g., stored or mapped) cached dynamic library 635 in a memory space (e.g., an address space) of dynamic link editor 534. By having cached dynamic library 635 in its own memory space, dynamic link editor 534 can load cached dynamic library 635 into a memory space (e.g., an address space) of one or more other processes (e.g., process 430 and/or one or more other processes executing one or more other software programs).

In some examples, dynamic link editor 534 performs one or more operations on cached dynamic library 635, such as relocation, symbol resolution, and/or Address Space Layout Randomization (ASLR) before loading cached dynamic library 635 into another process. Such operations can be performed in the memory space of dynamic link editor 534 and prevent such operations from being performed after receiving a request to load a software program that requires cached dynamic library 635. In some examples, cached dynamic library 635 includes pre-linked binary of a dynamic library that can be loaded into another process.

While illustrated as a dynamic library, it should be recognized that dynamic link editor 534 can cache data other than or in addition to dynamic libraries. For example, dynamic link editor 534 can cache executable files.

In some examples, data included in dynamic link editor 534 is included in a searchable list of cached data for fast mapping into other processes. To control the amount of memory the cache occupies, a timestamp of last use can be updated when (e.g., each time, every time, and/or some of the times) a cached entry is used. At a periodic interval, the cached entries can be evicted based on a configurable time (e.g., all data or most data used before that time are removed from the cache).

FIG. 7 is a flow diagram illustrating method 700 for executing a software program. Some operations in method 700 are, optionally, combined, the orders of some operations are, optionally, changed, and some operations are, optionally, omitted. In some examples, method 700 is performed by a compute system (e.g., compute system 100, device 200, or computer system 300) as part of executing a software program. In some examples, method 700 is performed by a first process of a computer system (in some examples, the first process is part of an operating system of the device (e.g., a loader); in some examples, the first process is separate from an operating system of the device such that the first process communicates with the operating system via one or more communications (e.g., a system call, an API call, a kernel call, and/or an interprocess communication); in some examples, the first process includes an address space and one or more threads of execution), wherein the first process is separate from an operating-system kernel (e.g., a kernel of an operating system) of the device (in some examples, the operating-system kernel is the only operating-system kernel executing on the device; in some examples, the operating-system kernel manages execution of the first process and/or the second process), and wherein the first process is executing a dynamic linker (in some examples, the dynamic linker is executed by the first process in response to an instruction from the operating-system kernel; in some examples, the dynamic linker is executed by the first process in response to an instruction from a loader associated with the operating system; in some examples, the dynamic linker is executing on a thread of the first process). In some examples, the first process is part of a scheme provided by the operating system though is executing in a different part of memory than the operating system.

At 710, method 700 includes receiving an indication associated with a second process (in some examples, the indication is of the second process; in some examples, the indication is of one or more dynamic libraries associated with a software program (1) to be executed by the second process or (2) executing by the second process; in some examples, the indication is received from a loader executing on the device; in some examples, the indication is received from an interface (e.g., a command-line interface) of the operating system; in some examples, the second process is configured to execute a software application), wherein the second process is separate from the first process, and wherein the second process is (1) to be executed by the device or (2) executing by the device.

At 720, method 700 includes determining, based on the indication, one or more dynamic linking operations associated with the second process (in some examples, the one or more dynamic linking operations correspond to a software application (1) to be executed by the second process or (2) executing by the second process; in such examples, the software application includes one or more dynamic libraries that require the one or more dynamic linking operations to be performed before at least one instruction of the software application is able to be executed).

At 730, method 700 includes performing the one or more dynamic linking operations for (e.g., on behalf of) the second process.

In some examples, the first process is separate from an (or any) operating system of (e.g., executing by) the device (in some examples, the first process is executing in user space rather than kernel space; in other examples, the first process is executing in kernel space and is not separate from the operating system; in some examples, the first process executes in a kernel mode; in some examples, the first process executes in a user mode, which is a more-restricted mode than the kernel mode (e.g., one or more instructions are allowed in the kernel mode and not the user mode; in such examples, the operating-system kernel is executing in the kernel mode).

In some examples, the first process has an address space (e.g., first user space) separate from an address space (e.g., second user space) of the second process (e.g., the address space of the first process does not overlap with the address space of the second process) (in some examples, the address space of the first process and the address space of the second process are each a virtual address space; in some examples, the second process has access to the address space of the second process but not the address space of the first process).

In some examples, the first process is configured (e.g., by a component of an operating system, such as a launcher) to be able to modify the address space of the second process (in some examples, the first process is launched with one or more entitlements that allow the first process to access one or more kernel operations to perform the one or more dynamic linking operations (e.g., a kernel call to modify the address space of the second process)).

In some examples, method 700 includes modifying (e.g., assembling) a process image to be executed by the second process (in some examples, the process image includes executable code required during execution of the second process; in some examples, the process image includes a code segment (or text segment) (e.g., a portion of object file or a program's address space (e.g., virtual address space) that includes executable instructions), a data segment (e.g., a portion of the object file or the program's address space that includes static and global variables), a stack segment (e.g., a return address to return after completion of function execution and an area of memory allotted for automatic variables and function parameters), and/or a heap segment (e.g., an area of memory allotted for dynamic memory storage)).

In some examples, method 700 includes receiving, from a loader (in some examples, the loader is included with (e.g., executing by) an operating system of the device; in some examples, the loader is a component that performs one or more operations including locating a program in offline storage, loading the program into main storage, and providing the program control of a process of the device; in some examples, the loader is configured to load one or more programs and/or one or more libraries; in some examples, the loader reads an executable file including program instructions into memory and performs one or more preparatory tasks to prepare the executable file for execution), a request to perform dynamic linking for the second process (in some examples, the request is received after a request to execute the second process and before executing executable instructions included with the second process), wherein the request is received before determining the one or more dynamic linking operations associated with the second process (in some examples, the loader initiates the dynamic linker with an entitlement to be able to modify the address space of the second process; in some examples, the kernel checks that the dynamic linker is configured to be able to modify (e.g., configured to modify) the address space of the second process; in some examples, the second process is configured to not be able to modify an address space of a different process).

In some examples, the first process performs the one or more dynamic linking operations before the second process executes an instruction (e.g., a first or single instruction) (in some examples, the first process performs the one or more dynamic linking operations before the second process (or a process image associated with the second process) is executed). In some examples, method 700 includes receiving, from the second process via an inter-process communication (e.g., after the second process executes an instruction), a request to perform an additional dynamic linking operation (in some examples, the additional dynamic linking operation is a request to include an additional dynamic library); and in response to receiving the request, performing the additional dynamic linking operation for (e.g., on behalf of) the second process.

In some examples, an operation of the one or more dynamic linking operations includes mapping a file (e.g., a dynamic library) to memory (e.g., virtual memory) corresponding to the second process, wherein the operation is performed by the first process communicating with the operating-system kernel via a kernel call (e.g., a system call).

In some examples, an operation of the one or more dynamic linking operations includes loading one or more libraries into memory associated with the second process (e.g., RAM), modifying code (e.g., code included with a process image of the second process) at runtime to call one or more functions corresponding to one or more libraries, resolving symbols in code (e.g., code included with a process image of the second process) to be executed by the second process, or performing Address Space Layout Randomization (ASLR).

In some examples, the first process has file-access (e.g., input and/or output) permission (e.g., access to read and/or write one or more files stored by the device), and wherein the second process never has file-access permission (e.g., the second process is never configured to be able to read and write a file stored in memory of the device) (in some examples, the second process never having file-access permission means that the second process is not able to access a dynamic library by itself during initialization or execution of the second process and rather that another process must access the dynamic library on behalf of the second process).

In some examples, the first process is executing a loader (in some examples, the loader is included with (e.g., executing by) an operating system of the device; in some examples, the loader is configured to load one or more programs and/or one or more libraries; in some examples, the loader reads an executable file including program instructions into memory and performs one or more preparatory tasks to prepare the executable file for execution). In some examples, method 700 includes identifying a software program to execute on the second process (in some examples, the software program corresponds to a request received by an operating system of the device, such as a request sent in response to user input or in response to an instruction executed with respect to another software program); loading at least a portion of the software program in memory associated with the second process; and providing control of a processor of the device to the second process.

In some examples, method 700 includes mapping one or more dynamic libraries into an address space (e.g., a virtual address space, a user space, and/or a kernel space) of the first process; and after mapping the one or more dynamic libraries into the address space of the first process: mapping at least one of the one or more dynamic libraries into: an address space (e.g., a virtual address space and/or a user space) of the second space; and an address space (e.g., a virtual address space and/or a user space) of a third process different from the first process and the second process (in some examples, the third process is configured to execute a different software application than the second process; in some examples, the third process is configured to execute another instance of the software application configured to be executed by the second process; in some examples, both the second process and the third process are configured to use the at least one of the one or more dynamic libraries during execution).

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

What is claimed is:

1. A method, comprising:
by a first process of a computer system, wherein the first process is separate from an operating-system kernel of the computer system, and wherein the first process is executing a dynamic linker:
receiving an indication associated with a second process, wherein the second process is separate from the first process, and wherein the second process is (1) to be executed by the computer system or (2) executing by the computer system;
determining, based on the indication, one or more dynamic linking operations associated with the second process; and
performing the one or more dynamic linking operations for the second process.

2. The method of claim 1, wherein the first process is separate from an operating system of the computer system.

3. The method of claim 1, wherein the first process has an address space separate from an address space of the second process.

4. The method of claim 3, wherein the first process is configured to modify the address space of the second process.

5. The method of claim 1, further comprising:
by the first process, modifying a process image to be executed by the second process.

6. The method of claim 1, further comprising:
by the first process, receiving, from a loader, a request to perform dynamic linking for the second process, wherein the request is received before determining the one or more dynamic linking operations associated with the second process.

7. The method of claim 1, wherein the first process performs the one or more dynamic linking operations before the second process executes an instruction.

8. The method of claim 7, further comprising:
by the first process:
receiving, from the second process via an inter-process communication, a request to perform an additional dynamic linking operation; and
in response to receiving the request, performing the additional dynamic linking operation for the second process.

9. The method of claim 1, wherein an operation of the one or more dynamic linking operations includes mapping a file to memory corresponding to the second process, wherein the operation is performed by the first process communicating with the operating-system kernel via a kernel call.

10. The method of claim 1, wherein an operation of the one or more dynamic linking operations includes loading one or more libraries into memory associated with the second process, modifying code at runtime to call one or more functions corresponding to one or more libraries, resolving symbols in code to be executed by the second process, or performing Address Space Layout Randomization (ASLR).

11. The method of claim 1, wherein the first process has file-access permission, and wherein the second process never has file-access permission.

12. The method of claim 1, further comprising:
by the first process, wherein the first process is executing a loader:
identifying a software program to execute on the second process;
loading at least a portion of the software program in memory associated with the second process; and
providing control of a processor of the computer system to the second process.

13. The method of claim 1, further comprising:
by the first process:
mapping one or more dynamic libraries into an address space of the first process; and
after mapping the one or more dynamic libraries into the address space of the first process:
mapping at least one of the one or more dynamic libraries into:
an address space of the second process; and
an address space of a third process different from the first process and the second process.

14. A non-transitory computer-readable storage medium storing one or more programs configured to be executed by one or more processors of a computer system, the one or more programs including instructions for:
by a first process of the computer system, wherein the first process is separate from an operating-system kernel of the computer system, and wherein the first process is executing a dynamic linker:
receiving an indication associated with a second process, wherein the second process is separate from the first process, and wherein the second process is (1) to be executed by the computer system or (2) executing by the computer system;
determining, based on the indication, one or more dynamic linking operations associated with the second process; and
performing the one or more dynamic linking operations for the second process.

15. A computer system, comprising:
one or more processors; and
memory storing one or more programs configured to be executed by the one or more processors, the one or more programs including instructions for:
by a first process of the computer system, wherein the first process is separate from an operating-system kernel of the computer system, and wherein the first process is executing a dynamic linker:
receiving an indication associated with a second process, wherein the second process is separate from the first process, and wherein the second process is (1) to be executed by the computer system or (2) executing by the computer system;
determining, based on the indication, one or more dynamic linking operations associated with the second process; and
performing the one or more dynamic linking operations for the second process.
